(19) United States
(12) Patent Application Publication
(10) Pub. No.: US 2012/0137235 A1
(43) Pub. Date: May 31, 2012

(54) DYNAMIC USER INTERFACE GENERATION

(76) Inventors: Sabarish T S, Bangalore (IN); Sagar Joshi, Bangalore (IN); Ganesh Kudva, Karkala (IN); Suresh Honnappanavar, Gadag (IN); Varun V S, Trivandrum (IN); Narendra N. Shukla, Ballia (IN)

(21) Appl. No.: 12/955,667

(22) Filed: Nov. 29, 2010

(51) Int. Cl. G06F 3/048

(52) U.S. Cl. 715/763

(57) ABSTRACT

A user interface of an application is identified as designated for presentation to a particular end user of the application, the user interface rendered based at least in part on a user interface template, the user interface template including a plurality of placeholders, and the user interface adapted to receive user inputs. At least one attribute of the particular end user is identified. A first set of user interface (UI) building blocks is selected from a plurality UI building blocks, the first set of UI building blocks including at least one configurable UI building block dynamically selected based on the identified attribute of the particular end user. At least one placeholder of the user interface template is populated with the first set of UI building blocks to render the user interface for presentation to the particular end user. The user interface is presented to a user of the application.

### TECHNICAL FIELD

This present disclosure relates to computer software graphical user interface technology, and, more particularly, to dynamic generation of a user interface.

### BACKGROUND

User interface elements can be displayed by a graphical user interface of a computing device and interacted with by users of the device. It is common in modern software applications for the application to have at least one such user interface element (“UI”) associated with it. Users can interact with a program's UI affecting a change in the UI displayed to the user as well as data manipulated by the application associated with the UI. Some applications are configured to accommodate the needs of various users, including users in various countries. Multiple versions of a UI can be developed and provided for users, for example, to accommodate multiple languages of users of the application. Typically, creating multiple versions of an application's UI involves the development of multiple parallel versions of the full UI. In essence, a developer can be required to develop a separate UI for each class of user for which a particular application is intended.

Some user interfaces allow users to input, modify, and delete data associated with various records, including records maintained on a database. Web-based applications and forms also exist that present a UI to a client device for a hosted application, for example, over the Internet. Web-based forms and UIs have been popularized with the rise of the Internet and distributed software environments. Some modern UI forms can also include conditional fields, where inputs for a prior field influence selectable options in other fields. Conditional UI fields can also be used for control flow of an electronic form or questionnaire, where subsequent UI screens presented to a user are based on a user's entries in a previously presented UI screen or form.

### SUMMARY

This disclosure provides various embodiments for dynamically generating a user interface. A user interface of an application can be identified as designated for presentation to a particular end user in a plurality of end users of the application, the user interface rendered based at least in part on a user interface template, the user interface template including a plurality of placeholders, and the user interface adapted to receive user inputs. At least one attribute of the particular end user can be identified. A first set of user interface (UI) building blocks can be selected from a plurality UI building blocks, the first set of UI building blocks including at least one configurable UI building block dynamically selected from a set of configurable UI building blocks based on the identified attribute of the particular end user. At least one placeholder of the user interface template can be populated with the first set of UI building blocks to render the user interface for presentation to the particular end user. The user interface can be presented to a user of the application, the user interface rendered for presentation to the particular end user.

While generally described as computer implemented software that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims

### DESCRIPTION OF DRAWINGS

FIG. 1 illustrates an example system for providing dynamic generation of a user interface form.

FIG. 2 is a schematic representation of an example dynamic user interface framework for use in connection with an enterprise software environment.

FIG. 3 is a flowchart of an example technique for dynamically generating a user interface.

FIG. 4 is a flowchart of an example technique for specifying parameters for dynamic generation of a user interface.

FIG. 5A is an example screenshot of a particular user interface generated based on attributes of a first end user.

FIG. 5B is an example screenshot of the particular user interface generated based on attributes of a second end user.

FIG. 6 is an example screenshot of a user interface for interpreting and specifying parameters for dynamic generation of a user interface.

Like reference symbols in the various drawings indicate like elements.

### DETAILED DESCRIPTION

Rather than recreating multiple versions of a single user interface for a particular software application, a user interface (UI) framework can be provided that is adapted to not only dynamically generate multiple versions of a single user interface, but generate potentially limitless different user interfaces for a corresponding wide array of applications, based, at least in part, on a set of reusable UI building blocks. A UI template can be defined for software applications, with the UI template including a placeholder. By populating the UI template's placeholder with reusable UI building blocks, a user interface can be generated for presentation to a user. Further, substitute UI building blocks can be defined for a subset of the UI template placeholders so that certain placeholders are alternately populated by the substitute UI building blocks when certain pre-defined conditions are met. Such conditions can relate to the identity of an end user for whom the particular user interface is intended. For instance, depending on an attribute of a particular user, one of a set of available UI building blocks can be selected for inclusion in the user interface intended to be provided to the user. Dynamically rendering a user interface in this manner can, for example, allow for user interfaces to be tailored to the identity of the user and the data desired to be collected through the user interface from the user. While traditional applications provide multiple, standalone versions of a single user interface, excessive programming and duplicative development can be avoided, among other advantages, by dynamically generating user interfaces based on a UI template populated by a set of re-usable, configurable UI building blocks.

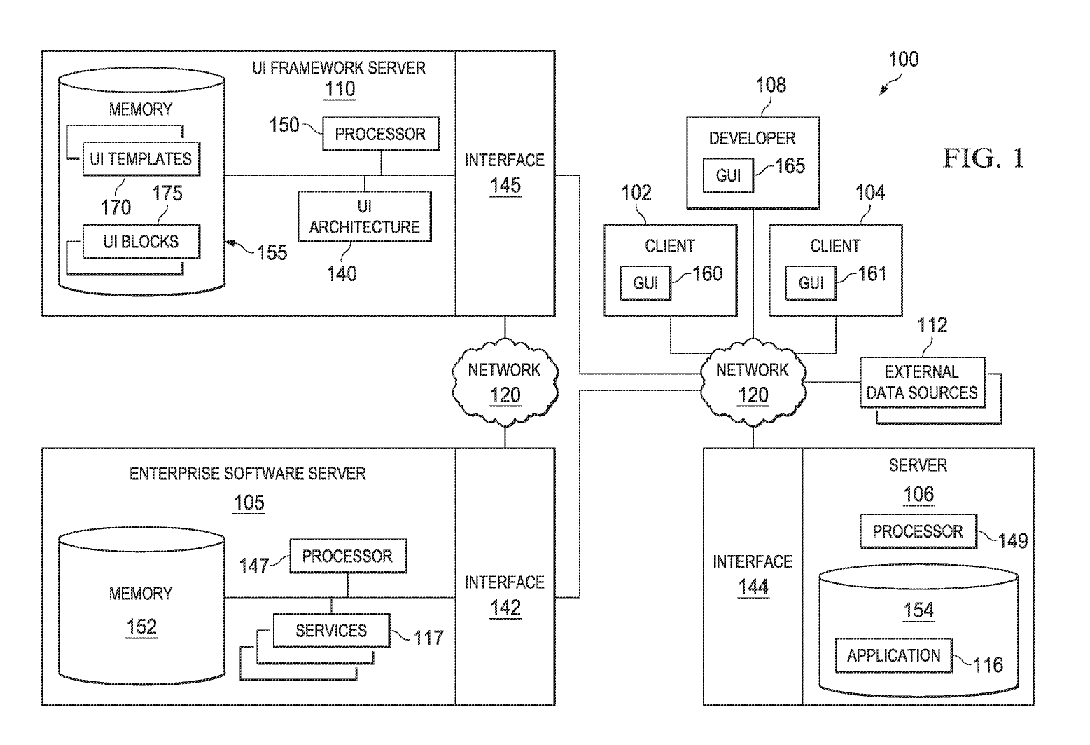

Turning to the example implementation of FIG. 1, the illustrated software environment 100 includes, or is communicably coupled with, one or more clients 102, 104, 108, one or more enterprise system servers 105, one or more application servers 106, a user interface framework server 110, and one or more data sources 112, using one or more networks 120. Each of the servers 105, 106, 110 comprise electronic computing devices operable to receive, transmit, process, store, or manage data and information associated with the software environment 100. As used in this document, the term “computer” is intended to encompass any suitable processing device. For example, the environment 100 may be implemented using computers other than servers, including a server pool. Further, any, all, or some of the servers 105, 106, 110 may be adapted to execute any operating system, including Linux, UNIX, Windows Server, or any other suitable operating system.

In the illustrated embodiment, the enterprise system server is one or more computing devices used to provide enterprise software services to one or more customers, such as illustrated clients 102, 104, 108. A UI framework server 110 can be provided in connection with the enterprise software system to provide re-usable user interface generation services for a plurality of applications or services (e.g., 117) served through the enterprise software system as well as through other application servers (e.g., 106). A UI architecture service 140 can be provided by the UI framework server 110, the UI architecture 140 adapted to provide dynamically-generated user interfaces for applications making use of the user interface functionality provided through the UI framework server 110. For instance, attributes of users of the applications consuming user interface services provided through the UI framework server 110, can be considered, based on the UI architecture 140, to customize a particular user interface generated for the corresponding application. Clients 102, 104, 108, as well as other users external to environment 100 or enterprise system server 105, can, directly or indirectly (e.g., via a proxy, virtual machine interface, etc.), access and use enterprise services provided by enterprise system server 105, including user interface services provided for applications of the enterprise software environment through the UI framework server 110.

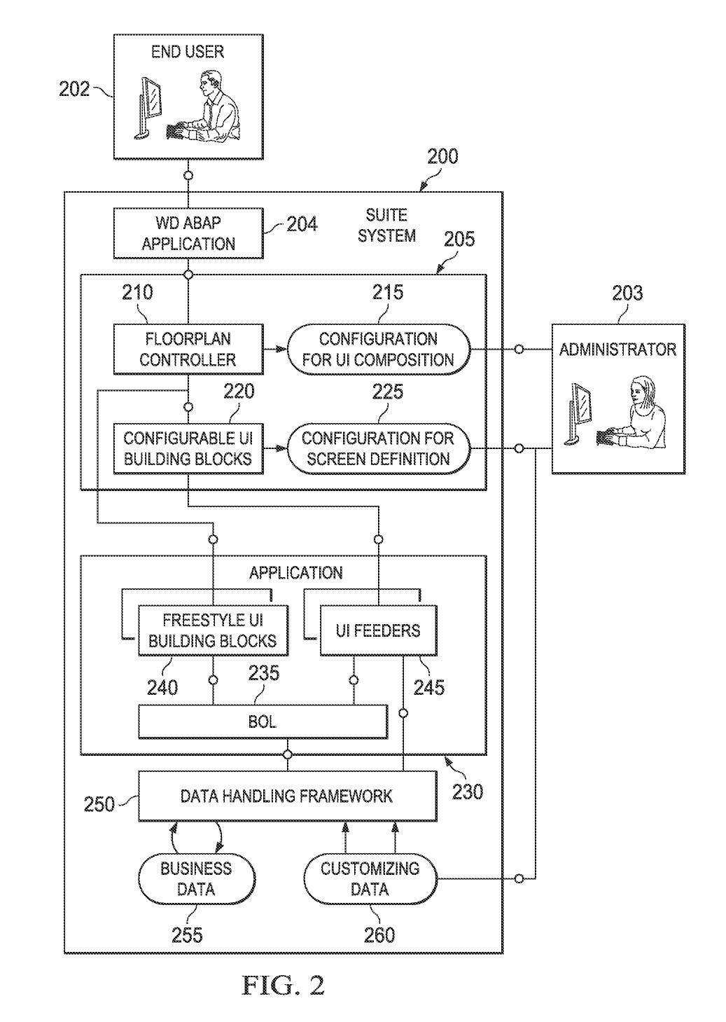

The UI framework architecture 140 can include a dynamic user interface generation or customization components. FIG. 2 is a schematic representation of an example dynamic user interface architecture 200 for use in connection with an enterprise software environment (e.g., 100). The architecture 200 can include a generic UI generation framework 205 including a screen controller 210, configurable UI composition templates 215, configurable UI building blocks 220, and screen definition logic 225. The UI generation framework 205 can interface with a particular enterprise software application 204 and provide UI functionality for the application 204. The application 204 can be one of many enterprise software applications provided through an enterprise software environment that utilize the UI functionality provided through the UI generation framework 205. In this sense, the UI generation framework 205 can be a shared framework for a plurality of software applications, including enterprise software applications, as well as other distinct and sometimes unrelated software applications developed to take advantage of the UI generation facilities of the UI generation framework 205. The user interfaces generated by the UI generation framework 205 can be adapted for presentation and interaction with an end user 202. The end user 202 can be a non-technical business user from whom business and personal data is needed or requested, or to whom business and personal data is presented. Accordingly, the functionality, design, and presentation of the user interface generated by the UI generation framework 205 can be adapted to be intuitive and user-friendly.

To assist in accommodating a user interface that is straightforward and easy to understand by the end user 202, the UI generation framework 205 can tailor user interfaces for a particular user so as to collect and present the needed information from and to the user in as straightforward a manner as possible. Accordingly, the UI generation framework 205 can include a screen controller 210 (or floorplan controller) adapted to dynamically generate a user interface for a particular application 204. The screen controller 210 can build a particular user interface by populating a particular user interface template 215 for the application 204 with configurable building blocks 220 according to specified screen definition logic 225. Screen definition logic 225 can affect and, in some cases, determine what building blocks 220 populate which frames or fields of a template 215 and under what conditions. For instance, screen definition logic 225, in some instances, can dictate that particular building blocks 220 populate a particular template 215 for the application 204 based on the identity or a characteristic of the end user 202 identified by the UI generation framework 205.

Screen definition logic 225 can be configurable by an administrator 203 authorized to maintain, modify, design, and define conditions and screen definition logic 225 associated with dynamically generating a particular user interface for a particular application 204. Additionally, the administrator 203 can specify, modify, customize, and otherwise configure the UI building blocks 220 and conditions associated with populating a template with particular UI building blocks 220. Further, an administrator 203 can control, modify, design, customize, and otherwise configure aspects of the user interface templates 215 used by the screen generator 210 in dynamically generating a user interface for a particular application 204. Configurable UI building blocks 220 can include interactive data gathering and data collection functionality. For instance, UI building blocks 220 can provide one or more fields, selectable menus, buttons, and other UI components that can be used to collect data from a user. Other UI building blocks 220 (also 240) can include UI flow features, for instance, to assist in directing and guiding users through a particular user interface form.

The architecture 200 can further include an application layer 230 associated with at least one application 204 using the UI generation framework 205. The application layer 230 can include a business object layer 235 (also referred to as, for example, a domain layer, business entity layer, or business logic layer). The business object layer (BOL) 235 can include and provide the business logic of the application 204. In this sense, the business logic layer is separated and insulated from the user interface layer (e.g., 205) and data access layer (e.g., 250).

In addition to configurable, reusable UI building blocks 220, the robustness of the user interfaces capable of being generated through the UI generation framework 205 can be further enhanced through the provision of additional application-specific “freestyle” UI building blocks 240 that are specifically customized to the requirements of the application 204 and usable in connection with the UI generation framework 205. A particular UI template 215, for instance, can be populated with one or more of application-specific UI building blocks 240 and configurable UI building blocks 220, including mixed combinations of customized UI building blocks 240 and configurable UI building blocks 220.

As configurable UI building blocks 220 are not necessarily application-specific, and are in some cases reusable in connection with multiple different applications 204, the application layer 230 can further include UI feeder modules 245 that can be used to interface with configurable UI building blocks 220 to impart application-specific UI requirements for consideration with the configurable UI building blocks 220 specified for use with the application 204. UI feeder modules 245 can also include transaction handlers adapted to provide operation handling between configurable building blocks 220 and a data handling framework 250 providing data operation (e.g., create, read, update, and delete (CRUD)) support and functionality for the building blocks 220. For instance, a UI feeder 245 can read the business object layer 235 to identify UI requirements for the application 204 and communicate these requirements to customize the functionality of the configurable UI building blocks for the application 204.

As a simplified example, certain configurable UI building blocks 220 can pertain to certain personal data fields, such as user name and user address. When displayed to the end user 202, the end user can add, modify, and delete text in these fields. In some examples, however, the business logic of the application 204 may require that a value always be provided in a particular field once a value has been entered, such as a value for the user name. In this illustrative example, the configurable UI building block 220 corresponding to a user name field can provide functionality for the user to freely delete an entry in some contexts while requiring the user to maintain a value within the fields in other contexts. A UI feeder 245 of a particular application 204 requiring that the user name value be maintained can identify this requirement in the business logic 235 of the application's application layer 230 and pass this requirement to the corresponding UI building block 220, thereby instructing the UI building block 220 to similarly require a value for the user name field when used in connection with user interfaces generated for this particular application 204. In another example, certain UI building blocks 220 should be grouped together in a particular user interface of a particular application. For instance, more that one UI building block 220 can be selected and included in a user interface to provide the address inputs for a form, such as one or more street address fields, city fields, country field, postal code field, etc. The UI feeder 245 can identify that the business logic 235 of the application requires certain fields to be grouped together or arranged in a particular order. Accordingly, the UI feeder 245 can impart these requirements to the configurable UI building blocks 220 to assist in having the corresponding UI building blocks 220 populate UI template placeholders with the grouped UI building blocks 220.

In addition to the UI generation framework 205 and application layer 230, the architecture 200 can further include a data handling framework 250, or data handling layer, adapted to provide database handling, data operation functionality and logic for use in connection with operations and functions provided through and in connection with user interfaces generated by the UI generation framework 205. For instance, the data handling framework 250 can provide, for example, the CRUD functionality used by UI building blocks 220, 240, UI objects (e.g., buttons, selectable menus, etc.), and other functionality commonly usable across various UI building blocks 220, 240 and user interfaces. The data handling framework 250 can provide a reusable, shared framework providing reusable data handling functionality for components of the architecture 200. The data handling framework 250 can be used to interface with and provide operations on data stores maintaining business data 255, including shared business data, used and accessed by various applications provided, for example, in an enterprise software environment. The functionality provided through the data handling framework 250 need not be fixed. For instance, data customization logic 260 can be defined and customized by an administrator 203 to thereby modify, supplement, and add functionality provided by the data handling framework 250.

Returning to FIG. 1, the UI framework server 110 can include one or more processors 150 executing software comprising the UI framework architecture 140. The processor 150 executes instructions and manipulates data to perform UI framework architecture 140 operations and tasks (described below) as well as serve user interface services, including those provided through UI architecture (such as UI generation framework 205), to a plurality of search service consumers, including enterprise software server 110, application servers 106 and applications (e.g., 116), systems, and programs remote from the UI framework server 110. To facilitate the provision of user interface services, UI framework server 110 can use configurable UI templates 170 and re-usable UI building blocks 175 adapted to populate one or more of the configurable UI templates 170 in the rendering or generation of a particular user interface on behalf of a particular application. The UI framework server 110 can be adapted to serve user interface services to consumers in a variety of contexts including local, private, distributed, enterprise, and cloud-computing software system environments. The UI framework server 110 can be implemented using a single processor 150 or multiple processors, including multiple processors operating in a network or pool of computing devices, including parallel processing and cloud computing environments.

A plurality of external data sources 112 can store, host, or serve additional templates and/or UI building blocks, for example, for use in connection with the UI framework architecture 140. The external data sources 112 can, in some instances, be associated with computing devices, applications and systems, including those outside of software environment 100. For instance, one or more of the external data sources 112 can be associated with or controlled by a particular application server 106, and in some cases associated computing systems and devices can create and manage at least a portion of the UI templates or UI building blocks maintained by the associated data source. The UI framework server 110 can use UI templates or UI building blocks stored, maintained, or served at external data sources in connection with the user interface service provided through the UI architecture 140. In some instances, data sources 112 can be a part of or otherwise associated with an enterprise software system (e.g., 105) including users and consumer clients (e.g., 102, 104, 108) of the enterprise software system or UI framework server 110.

In the present example, enterprise system servers 105, application servers 106, and UI framework servers 110 can each include at least one interface (142, 144, 145, respectively), one or more processors (147, 149, 150, respectively), and computer-readable memory (152, 154, 155, respectively). In some instances, some combination of enterprise system servers 105, application servers 106, and UI framework servers 110 can be hosted on a common computing system, server, or server pool, and share computing resources, including shared memory, processors, and interfaces. The interfaces 142, 144, 145 can be used for communicating with other systems in a client-server or other distributed environment (including within environment 100) connected to the network 120, for example the one or more clients 108, external data sources 112, or any other computing device adapted to interface with the servers 105, 106, 110, including devices not illustrated in FIG. 1. Generally, each interface 142, 144, 145 comprises logic encoded in software and/or hardware in a suitable combination and operable to communicate with the network 120. More specifically, the interfaces 142, 144, 145 may comprise software supporting one or more communication protocols associated with communications such that the network 120 or hardware is operable to communicate physical signals within and outside of the illustrated software environment 100.

Each of the example servers 105, 106, 110 also includes a processor (147, 149, 150, respectively). Each processor 147, 149, 150 executes instructions and manipulates data to perform the operations of the associated server 105, 106, 110, and may comprise, for example, a central processing unit (CPU), a blade, an application specific integrated circuit (ASIC), or a field-programmable gate array (FPGA), among other suitable options. Although each processor 147, 149, 150 is illustrated as a single processor, multiple processors may be used according to the particular needs of the associated server. References to a single processor 147, 149, 150 are meant to include multiple processors where applicable. The operations that each processor 147, 149, 150 executes are determined by the purpose and operations of its associated server. Generally, the processor 147, 149, 150 executes instructions and manipulates data to perform the operations of its respective server and, specifically, the software systems, services, and applications hosted by the servers 105, 106, 110.

At a high level, each “server” (e.g., 105, 106, 110) includes one or more electronic computing devices operable to receive, transmit, process, store, or manage data and information associated with the environment 100. Specifically, a server is responsible for receiving requests from one or more clients and sending the appropriate response the requesting client. In addition to requests from external clients, requests may also be sent from internal users, external or third-party customers, other automated applications, as well as any other appropriate entities, individuals, systems, or computers. For example, although FIG. 1 illustrates a single server for each of enterprise system server 105, application server 106, and UI framework server 110, a server can be implemented using two or more servers, as well as computers other than servers, including a server pool. Indeed, a server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 may be adapted to execute any operating system, including Linux, UNIX, Windows, Mac OS, or any other suitable operating system.

In the case of an application server 106, the processor 149 can execute the functionality required to receive and respond to requests from clients, as well as client applications interfacing with the server's hosted application 116. It will be understood that the term “application server” (e.g., 106) can include any suitable software component or module, or computing device(s) capable of hosting and/or serving a software application, including distributed, enterprise, or cloud-based software applications. Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. Applications can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate.

At a high level, each of the one or more hosted applications and services (e.g., 116, 117, 140) illustrated in the environment 100 can include any application, program, module, process, or other software that may execute, change, delete, generate, or otherwise manage information according to the present disclosure, particularly in response to and in connection with one or more requests received from the illustrated clients 102, 104, 108, as well as other applications. In certain cases, only one hosted application may be located at a particular server. In others, a plurality of related and/or unrelated hosted applications may be stored at a single server, or located across a plurality of other servers, as well. In certain cases, environment 100 may implement a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via the network 120 (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client (e.g., 102, 104, 108). Moreover, any or all of the hosted applications and software service may be a child or sub-module of another software module or enterprise application (not illustrated) without departing from the scope of this disclosure. Still further, portions of a hosted application can be executed by a user working directly at a server (e.g., 106) hosting the application, as well as remotely at a client (e.g., 102).

Each of the example servers 105, 106, 110 also includes a memory (152, 154, 155, respectively). Further repositories 112, 114, 115 also each include at least one memory device. Each memory may include any memory or database module and may take the form of volatile or non-volatile memory including, without limitation, non-transitory memory elements, magnetic media, optical media, random access memory (RAM), read-only memory (ROM), removable media, or any other suitable local or remote memory component. Each memory may store various objects or data, including classes, frameworks, applications, backup data, business objects, jobs, web pages, web page templates, database tables, content repositories storing business or other dynamic information, or other information including any parameters, variables, algorithms, instructions, rules, constraints, or references thereto relevant to the purposes of the particular server. Each memory may also include any other appropriate data, such as VPN applications, firmware logs and policies, firewall policies, a security or access log, print or other reporting files, as well as others. Again, the particular data and instructions stored in each memory (e.g., 152, 154, 155) will be described in detail below in connection with the illustrated implementations of the software environment 100 and components thereof

Generally, the network 120 facilitates wireless or wireline communications between the components of the software environment 100 (e.g., between the UI framework server 110, data sources 112, and one or more clients (e.g., 102, 104, 108), the UI framework server 110 and the enterprise system server 105, the enterprise system server 105 and clients (e.g., 102, 104, 108), as well as between other components as appropriate), as well as with any other local or remote computer, such as those associated with one or more applications or external data sources. The network 120 can be implemented as one or more distinct networks. In any implementation, the network 120 may be a continuous or discontinuous network without departing from the scope of this disclosure, so long as at least a portion of the network 120 may facilitate communications between senders and recipients. The network 120 may be all or a portion of an enterprise or secured network. As an example, in FIG. 1 networks 120 may represent a portion of an enterprise network, or a connection to the Internet. In some instances, a portion of the network 120 may be a virtual private network (VPN). All or a portion of the network 120 can comprise either a wireline or wireless link. Example wireless links may include 802.11a/b/g/n, 802.20, WiMax, and/or any other appropriate wireless link. In other words, the network 120 encompasses any internal or external network, networks, sub-network, or combination thereof operable to facilitate communications between various computing components inside and outside the illustrated environment 100. The network 120 may communicate, for example, Internet Protocol (IP) packets, Frame Relay frames, Asynchronous Transfer Mode (ATM) cells, voice, video, data, and other suitable information between network addresses. The network 120 may also include one or more local area networks (LANs), radio access networks (RANs), metropolitan area networks (MANs), wide area networks (WANs), all or a portion of the Internet, and/or any other communication system or systems at one or more locations.

The illustrated implementation of FIG. 1 includes one or more local and/or remote clients 102, 104, 108. A client 102, 104, 108 can be any computing device operable to connect or communicate at least with the application server 106 and/or the network 120 using a wireline or wireless connection. Each client 102, 104, 108 includes at least one GUI (e.g., 160, 161, 165). In general, the client 102, 104, 108 comprises an electronic computing device operable to receive, transmit, process, and store any appropriate data associated with the software environment of FIG. 1. It will be understood that there may be any number of clients 102, 104, 108 associated with environment 100, as well as any number of clients 102, 104, 108 external to environment 100. Further, the term “client” and “user” may be used interchangeably as appropriate without departing from the scope of this disclosure. Moreover, while each client 102, 104, 108 is described in terms of being used by one user, this disclosure contemplates that many users may use one computer or that one user may use multiple computers. As used in this disclosure, the client 102, 104, 108 is intended to encompass a personal computer, touch screen terminal, workstation, network computer, kiosk, wireless data port, smart phone, personal data assistant (PDA), one or more processors within these or other devices, or any other suitable processing device. For example, the client 102, 104, 108 may comprise a computer that includes an input device, such as a keypad, touch screen, mouse, or other device that can accept information, and an output device that conveys information associated with operations of one or more applications stored and/or executed on an application server (or other servers in environment 100) or on the client 102, 104, 108 itself, including digital data, visual information, or GUI 160, 161, 165. Both the input device and the output device may include fixed or removable storage media such as a magnetic computer disk, CD-ROM, or other suitable media to both receive input from and provide output to users of the clients 102, 104, 108 through the display, namely the GUI 160, 161, 165.

The GUI 160, 161, 165 comprises a graphical user interface operable to allow the user to interface with at least a portion of environment 100 for any suitable purpose, including allowing a user to interact with one or more software applications making use of user interface services provided through the UI framework server 110, including services 117 provided through the enterprise software server 105. Generally, the GUI 160, 161, 165 provides users with an efficient and user-friendly presentation of data provided by or communicated within the system. The term “graphical user interface,” or GUI, may be used in the singular or in the plural to describe one or more graphical user interfaces and each of the displays of a particular graphical user interface. Therefore, the GUI 160, 161, 165 can be any graphical user interface, such as a web browser, touch screen, or command line interface (CLI) that processes information in the environment 100 and efficiently presents the results to the user. In general, the GUI 160, 161, 165 may include a plurality of user interface (UI) elements such as interactive fields, pull-down lists, media players, tables, graphics, virtual machine interfaces, buttons, etc. operable by the user at the client 108. These UI elements may be related to the functions of one or more applications or services (e.g., 116, 117, 140), including applications hosted locally at the client.

While FIG. 1 is described as containing or being associated with a plurality of elements, not all elements illustrated within environment 100 of FIG. 1 may be utilized in each alternative implementation of the present disclosure. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

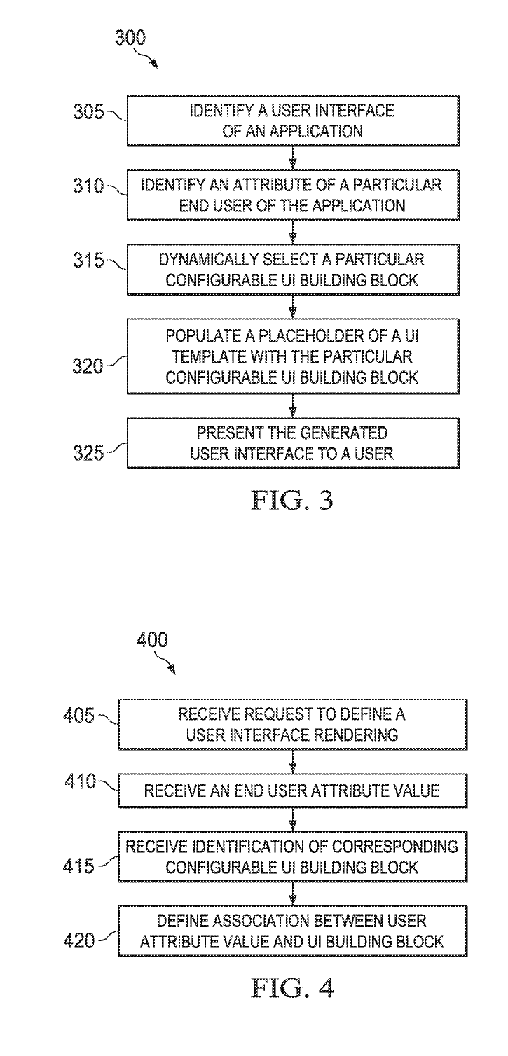

Turning now to the flowchart 300 of FIG. 3, an example technique is shown for dynamically generating a user interface for a software application. A particular user interface of an application can be identified 305, the user interface designated for presentation to a particular end user of the application, where the particular end user is one of a plurality of end users of the application. The user interface can be adapted to receive user inputs and further adapted to be rendered based at least in part on a particular UI template. A UI template can include a plurality of placeholders defining, in some instances, the type and positioning of UI content and functionality provided in a particular user interface. In some instances, the template itself can be configurable, customizable, or modifiable by an administrator to tailor the template to the needs of the application or to a particular user of the application. An attribute of the particular end user can be identified 310, for example, through log-in, session, IP-address, or authentication data entered by or collected from the user. Based, at least in part, on the identified user attribute, at least one configurable UI building block is dynamically selected 315 from a set of configurable UI building blocks available to populate 320 one or more placeholders of the user interface template. The selected configurable UI building blocks can then populate 320 one or more corresponding template placeholders. Other UI building blocks, such as application-specific UI building blocks, or freestyle building blocks, can also be used to populate certain placeholders of the UI template to render or generate a user interface for the application adapted for presentation to the particular end user. The generated user interface, rendered for presentation to the particular end user, can then be presented 325 to a user of the application.

In some instances, user interfaces dynamically generated from the same UI template can differ in appearance and/or functionality based on the identity of the end user for whom the user interface is generated. For instance, a first user interface, generated from a first UI template based on attributes of a first user can differ from a second user interface, generated from the same first UI template based on attributes of a second user. Differences between the first and second user interfaces, in this example, can be accounted for by virtue of different UI building blocks being used to populate the first UI template, thereby generating two different user interfaces. UI building blocks can also be used across different UI templates and in connection with different applications. Application business logic can also influence which UI building blocks are selected, as well as how a particular UI building block functions and appears when rendered into a user interface for presentation to a user.

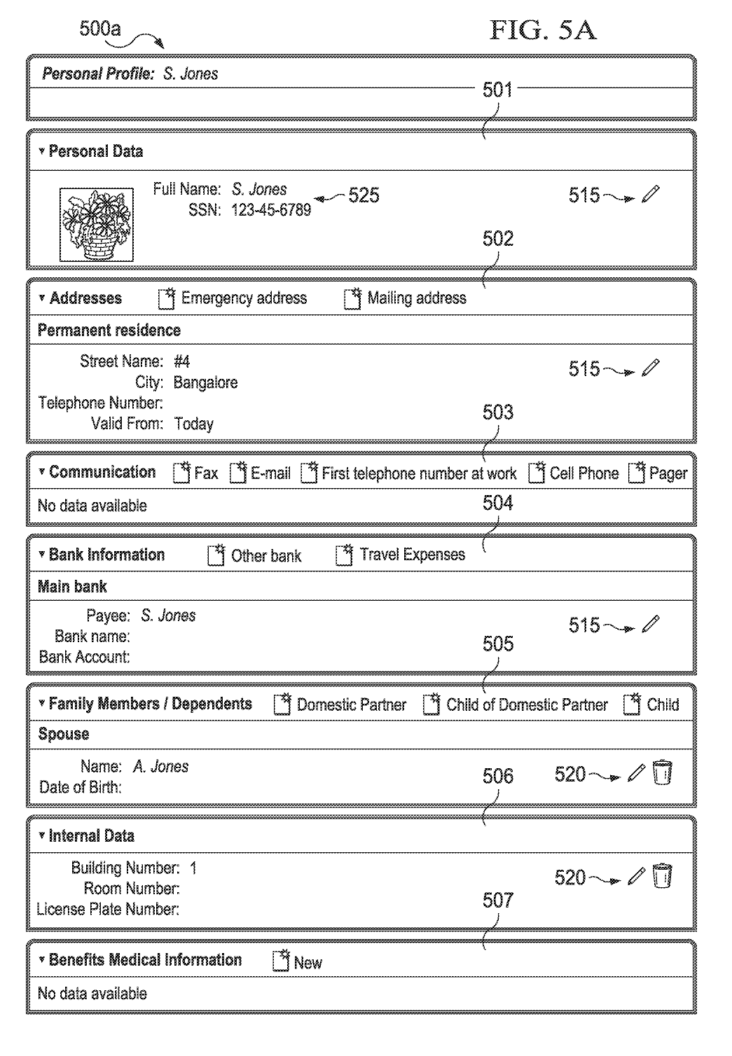

Turning now to the flowchart 400 of FIG. 4, an example technique is shown for specifying parameters for dynamic generation of a user interface. The specification of parameters can define the use of configurable UI building blocks for use in dynamically generating a user interface rendered for presentation to a particular end user of a particular application. A request can be received 405 from an end user, such as an authorized administrator, to define renderings of a configurable user interface template, where the configurable user interface template is adapted to render a user interface of an application and includes one or more placeholders. A subset of placeholders in the plurality of placeholders can be adapted to be dynamically populated by at least one configurable UI building block in a plurality of configurable UI building blocks based at least in part on an identified attribute of an end user. Receiving 405 the request can include receiving 410 an identification of a first value for an end user attribute code corresponding to a first attribute of an end user, and receiving 415 an identification of a first UI block in the plurality of configurable UI building blocks. A user attribute code can correspond to a particular attribute of a user, such as nationality, country of residence, employment status, employer, position, role, security clearance, and other attributes. The value can be one of a plurality of available values for the user attribute. For example, the value of a nationality user attribute code can be “United States,” “Germany,” or “India,” for example. Based on the received request, a first association can be defined 420 between the first value for the end user attribute code and the first UI building block. Subsequent presentations of the user interface to end users identified as associated with the first real world attribute can be rendered to include populating a particular placeholder in the subset of placeholders with the first UI building block based at least in part on the first association.

A user can define associations between multiple user attribute code values and UI building blocks, including multiple, alternative UI building blocks configurable for population in a single placeholder of a particular UI template. Indeed, one or more requests can be received from one or more users to define multiple block-attribute associations for multiple UI template placeholders. In some implementations, a UI building block is reusable across multiple UI templates and applications, potentially limitless user interfaces can be defined and generated from a common set of configurable UI building blocks. Moreover, multiple versions of each user interface, defined and generated from a common set of configurable UI building blocks, can be generated based on the same set of configurable UI building blocks. For instance, two different user interfaces can incorporate a defined association between a particular configurable UI building block and a user attribute to both realize multiple user interface versions.

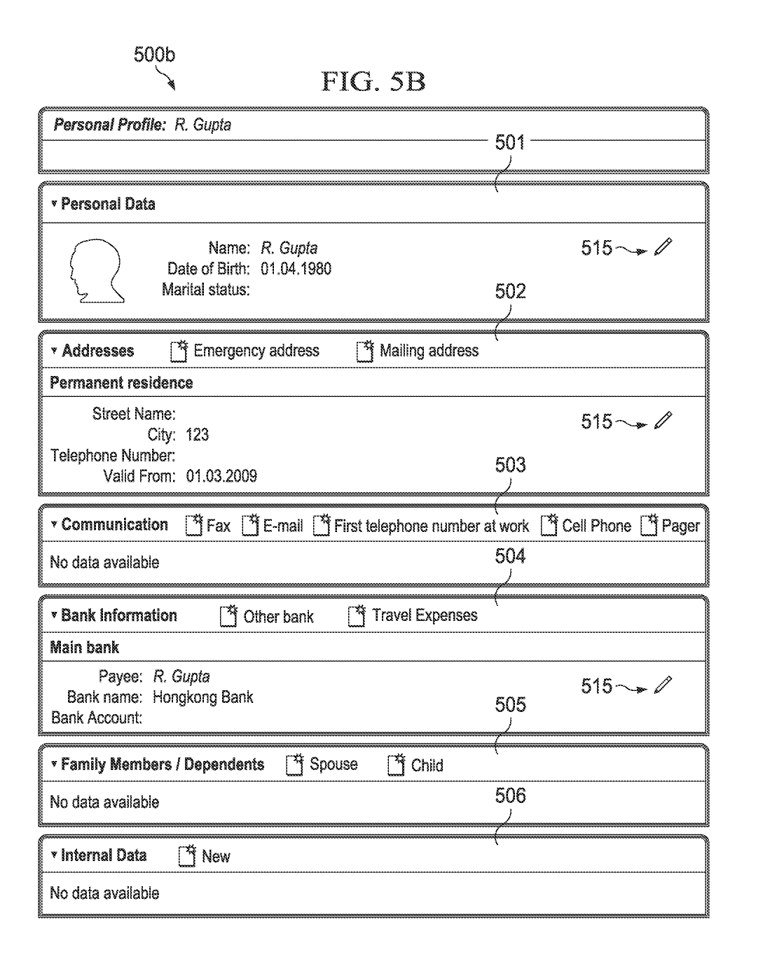

FIGS. 5A and 5B are example screenshots of a particular user interface 500 generated based on attributes of a particular user. The user interface 500 includes a plurality of blocks 501-507 corresponding to UI building blocks selected from a plurality of available UI building blocks adapted to populate placeholders of a particular user interface template. In the example of FIG. 5A, the user interface relates to an application collecting personal data from a user. The personal data can be used, for example, in connection with a company's human resources department, allowing end users to update their personal information themselves when or if certain personal data changes. This can allow data entry and updating responsibilities to be decentralized away from human resources employees to the persons most in tune with the data to be gathered—the employees themselves. The user interface is adapted to provide a simple, controlled interface that provides a minimal level of control and functionality to the end user, thereby controlling, and in some cases, limiting the extent to which a particular end user can access and change data. In this example, an end user can only edit 515 (i.e., update and add to) certain grouped fields of user data and is allowed to both edit and delete 520 certain other, non-critical data fields. Other fields may only allow the user to read previously-entered data.

In the simplified example of FIGS. 5A and 5B, national citizenship of the user can be an attribute identified and considered in populating a user interface with particular UI building blocks. For instance, the user interface 500a is generated based on at least one attribute of a first identified end user “S. Jones,” including the national citizenship of the first user. In this example, the national citizenship of the first user is identified as “United States.” Accordingly, at least one UI building block, corresponding with at least block 501 was dynamically selected on the basis that the first user's national citizenship was “United States” to provide, among other fields, an editable field 525 for the user's social security number (or SSN). FIG. 5B, on the other hand, illustrates a screenshot of the user interface shown in FIG. 5A, this time generated for a second user with a different national citizenship than the first, American user. In the example of FIG. 5B, the user's national citizenship is identified as “Indian.” Because only users with U.S. citizenship would have a social security number, FIG. 5A was generated to include a block providing functionality to allow the user to confirm and potentially edit the social security number on file with the human resources department of the first end user's employer. The user interface 500b generated for the Indian user, however, did not require a social security number field, considering that the Indian user likely does not possess a U.S. social security number. While a social security number field could have been provided for both users in FIGS. 5A and 5B, in order to simplify the interface 500, and avoid the likelihood that the end user is confused by the interface and incorrect information entered, one or more fields and user interface blocks can be presented to the user tailored to one or more attributes of the user. Other fields, beyond the social security number can also be affected based on an identification of a user's national citizenship. For instance, UI building blocks incorporating certain address fields specific to a particular country can be selected. Additional name fields can be provided, including fields that provide for name formatting and name order adapted to the languages and customs of a particular nationality. In still other examples, medical benefits information (e.g., 517) can be adapted to the user based on the user's citizenship, for instance, to take in account a user's eligibility or enrollment in certain government-managed health care programs or the availability of private medical benefits (i.e., in countries without centralized health care). Additionally, other user attributes can be considered to tailor certain features and fields of a dynamically-generated user interface of an application beyond users' national citizenship. For instance, the identification of the organization, employment status, employment role, permissions, contract status, and other attributes of the employee can be considered and used.

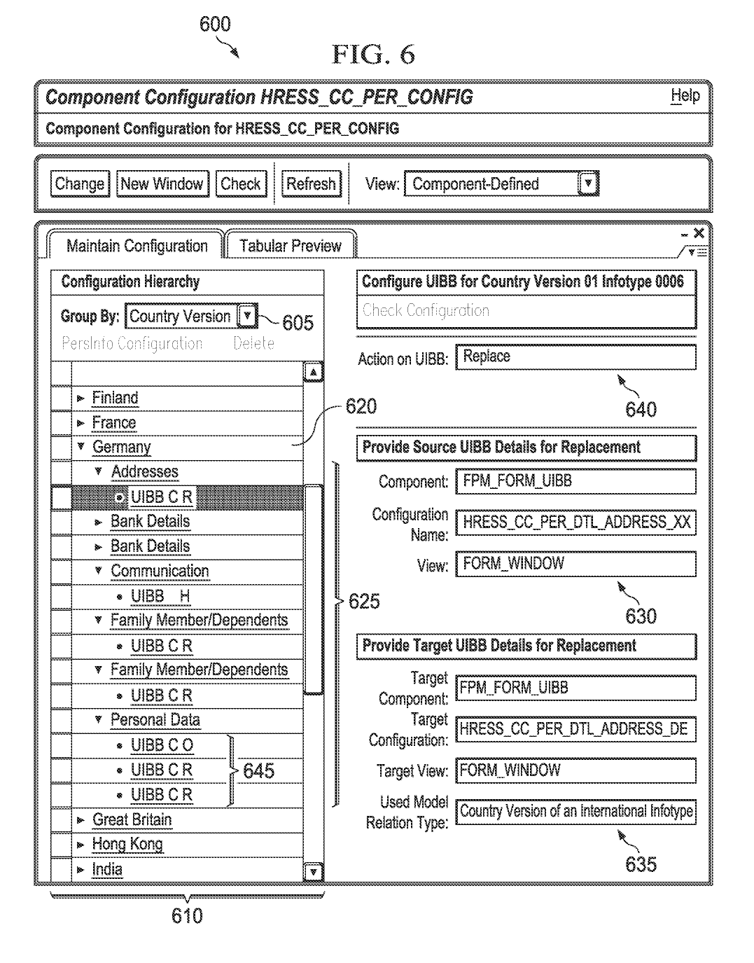

As discussed above, dynamic generation of a user interface using configurable UI building blocks can be customized, modified, and configured by an end user, such as an authorized administrator. FIG. 6 is a screenshot of an example user interface 600 for interpreting and specifying parameters for dynamic generation of a user interface, for example, to customize a particular user interface of an application to a particular end user based on one or more identified attributes of the user. In this example, an authorized user can specify associations between particular user attributes and particular configurable UI building blocks that can populate a UI template of an application. For instance, as shown in FIG. 6, a user can specify a particular user attribute type 605 to be considered in populating a UI template with one or more configurable UI building blocks. The selection of an attribute, in dropdown menu 605 can result in the presentation of a listing 610 of available values for the selected user attribute. In the example screenshot of user interface 600, a user attribute has been selected relating to a country, such as a nationality, citizenship, residency, birthplace, or other user attribute associated with a country. The selection of the country attribute can result in a listing 610 of countries.

Continuing with the example of FIG. 6, an end user can select a particular attribute value from the listing 610 (in this case “Germany”) and specify a particular UI building block to be associated with a particular placeholder for a particular UI template. The corresponding UI template (and user interface) can also be specified by the administrator-user on the user interface. Based on the specification of a particular UI template, selection of a particular attribute value (e.g., 620) displayed in the attribute listing 610, can result in the presentation of a sub-listing 625 of available placeholders for which a UI building block can be specified. The administrator-user can specify one or more configurable UI building blocks for each of the placeholders presented in the sub-listing 625. As an example, in FIG. 6, an administrator-user has designated (using fields 630, 635) that an originally-designated or default UI building block (specified at 630), “HRESS_CC PRES_DTL_ADDRESS XX,” designated to populate one or more placeholders associated with “Address,” be replaced with configurable UI building block “HRESS_CC_PRES_DTL_ADDRESS_DE” (specified at 635), when a particular user attribute value equals “Germany.” Further, in this example, the user has indicated that the newly designated UI building block is to replace the original building block, for example, through field 640.

While the example described above, pertaining to an “Address” placeholder, included the specification 635 of only a single configurable UI building block for use in populating the placeholder, other placeholders can provide for multiple UI building blocks (e.g., 645). Further, in some instances, an additional listing (not shown) can also be provided that presents a set of available UI building blocks for selection to the user, to assist the user in designating associations between particular configurable UI building blocks and user attribute values. A listing of available configurable UI building blocks can also include configurable building blocks hosted, stored, or maintained by third-party, remote, or external data sources. Configurable UI building blocks can be re-used across and in connection with multiple UI templates and applications utilizing the UI framework. Accordingly, as an example, the configurable UI building block “HRESS_CC_PRES_DTL_ADDRESS_DE,” designated by the user for the application in the example of FIG. 6, can also be designated for use in connection with the generation of other user interfaces, including user interfaces of other applications consuming user interfaces services provided by a corresponding UI framework.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Other variations are within the scope of the following claims.

What is claimed is:

1. A computer-implemented method comprising:
identifying a user interface of an application designated for presentation to a particular end user in a plurality of end users of the application, the user interface rendered based at least in part on a user interface template, the user interface template including a plurality of placeholders, and the user interface adapted to receive user inputs;
identifying at least one attribute of the particular end user;
selecting a first set of user interface (UI) building blocks from a plurality UI building blocks, the first set of UI building blocks including at least one configurable UI building block dynamically selected from a set of configurable UI building blocks based on the identified attribute of the particular end user;
populating at least one placeholder of the user interface template with the first set of UI building blocks to render the user interface for presentation to the particular end user; and
presenting the user interface to a user of the application, the user interface rendered for presentation to the particular end user.

2. The method of claim 1, where the particular end user is a first end user, the method further comprising:
identifying at least one attribute of a second end user, wherein the at least one attribute of the second end user is different from the at least one identified attribute of the first end user;
selecting a second set of UI building blocks from the plurality UI building blocks, wherein the second set of selected UI building blocks does not include the at least one configurable UI building block included in the first set of UI building blocks;
populating the user interface template with the second set of UI building blocks to render the user interface for presentation to the second end user; and
presenting the user interface, adapted for presentation to the second end user, to a user of the application.

3. The method of claim 2, wherein the second set of UI building blocks includes a second configurable UI building block dynamically selected from the set of configurable UI building blocks based on the identified attribute of the second user, wherein the second configurable UI building block is not included in the first set of UI building blocks.

4. The method of claim 1, wherein the application is adapted to collect, update, and collect personal information from end users in the plurality of end users.

5. The method of claim 4, wherein the application relates to human resources management.

6. The method of claim 1, wherein the application comprises a first application, the method further comprising:
identifying a user interface of a second application;
rendering the user interface of the second application for presentation to a user by populating based at least in part on a second user interface template, wherein rendering the user interface of the second application includes populating at least one placeholder in the second user interface template with a second set of UI building blocks from the plurality UI building blocks.

7. The method of claim 6, wherein the second set of UI building blocks also includes the at least one configurable UI building block, the at least one configurable UI building block providing functionality for the respective user interfaces of the first application and the second application, wherein the functionality provided through the at least one configurable UI building block for the first application is different from functionality provided through the at least one configurable UI building block for the second application.

8. The method of claim 6, wherein the first and second applications are applications within an enterprise software system.

9. The method of claim 1, wherein selecting the at least one configurable UI building block in the first set of user interface (UI) building blocks is based on a configurable screen definition.

10. The method of claim 1, wherein the first set of UI building blocks includes at least one application-specific UI building block.

11. The method of claim 1, further comprising:
identifying business logic of the application;
adapt at least one attribute of the at least one configurable UI building block based at least in part on the identified business logic.

12. The method of claim 11, wherein the at least one attribute corresponds to functionality of the at least one configurable UI building block.

13. A system comprising:
at least one data repository including at least one computer-readable storage device and storing a plurality of user interface (UI) building blocks and a set of user interface templates;
a user interface framework implemented on at least one computer, the user interface framework operable to interact with the at least one data repository and perform operations comprising:
identifying a user interface of an application designated for presentation to a particular end user in a plurality of end users of the application, the user interface rendered based at least in part on a user interface template in the set of user interface templates, the user interface template including a plurality of placeholders, and the user interface adapted to receive user inputs;
identifying at least one attribute of the particular end user;
selecting a first set of user interface (UI) building blocks from the plurality UI building blocks, the first set of UI building blocks including at least one configurable UI building block dynamically selected from a set of configurable UI building blocks based on the identified attribute of the particular end user;
populating at least one placeholder of the user interface template with the first set of UI building blocks to render the user interface for presentation to the particular end user; and
presenting the user interface to a user of the application, the user interface rendered for presentation to the particular end user.

14. The system of claim 13, wherein the user interface framework is implemented in connection with an enterprise software system.

15. The system of claim 14, wherein the application is provided as a service through the enterprise software system.

16. A computer-implemented method comprising:
receiving a request from an end user to define renderings of a configurable user interface template, the configurable user interface template adapted to render a user interface of an application and including a plurality of placeholders, wherein a subset of placeholders in the plurality of placeholders are adapted to be dynamically populated by at least one configurable UI building block in a plurality of configurable UI building blocks based at least in part on an identified attribute of an end user, wherein the request includes:
an identification of a first value for an end user attribute code corresponding to a first attribute of the end user; and
an identification of a first UI building block in the plurality of configurable UI building blocks; and
defining a first association between the first value for the end user attribute code and the first UI building block, wherein rendering subsequent presentations of the user interface to end users identified as associated with the first real world attribute are to include populating a particular placeholder in the subset of placeholders with the first UI building block based at least in part on the first association.

17. The method of claim 16, further comprising:
receiving a request including an identification of a second value for the end user attribute code corresponding to a second real world attribute of an end user, and an identification of a second, alternative UI building block in the plurality of configurable UI building blocks; and
defining a second association between the second value for the end user attribute and the second UI building block, wherein rendering subsequent presentations of the user interface to end users identified as associated with the second real world attribute are to include populating the particular placeholder with the second UI building block based at least in part on the second association.

18. The method of claim 16, further comprising:
receiving a request to modify the configurable user interface template;
modifying at least one attribute of the configurable user interface template based on the request.

19. The method of claim 16, wherein the request further includes an identification of the particular placeholder.

20. An article comprising a non-transitory, machine-readable storage device storing instructions operable to cause at least one processor to perform operations comprising:
identifying a user interface of an application designated for presentation to a particular end user in a plurality of end users of the application, the user interface rendered based at least in part on a user interface template, the user interface template including a plurality of placeholders, and the user interface adapted to receive user inputs;
identifying at least one attribute of the particular end user;
selecting a first set of user interface (UI) building blocks from a plurality UI building blocks, the first set of UI building blocks including at least one configurable UI building block dynamically selected from a set of configurable UI building blocks based on the identified attribute of the particular user;
populating at least one placeholder of the user interface template with the first set of UI building blocks to render the user interface for presentation to the particular end user; and
presenting the user interface to a user of the application, the user interface rendered for presentation to the particular end user.

21. An article comprising a non-transitory, machine-readable storage device storing instructions operable to cause at least one processor to perform operations comprising:
receiving a request from a user to define renderings of a configurable user interface template, the configurable user interface template adapted to render a user interface of an application and including a plurality of placeholders, wherein a subset of placeholders in the plurality of placeholders are adapted to be dynamically populated by at least one configurable UI building block in a plurality of configurable UI building blocks based at least in part on an identified attribute of an end user, wherein the request includes:
an identification of a first value for an end user attribute code corresponding to a first attribute of an end user; and
an identification of a first UI building block in the plurality of configurable UI building blocks; and
defining a first association between the first value for the end user attribute code and the first UI building block, wherein rendering subsequent presentations of the user interface to end users identified as associated with the first real world attribute are to include populating a particular placeholder in the subset of placeholders with the first UI building block based at least in part on the first association.
